(19) United States
(12) Patent Application Publication
(10) Pub. No.: US 2021/0296739 A1
(43) Pub. Date: Sep. 23, 2021

(54) SOLID-STATE BATTERY CELL

(71) Applicant: HONDA MOTOR CO., LTD., Tokyo (JP)

(72) Inventors: Shigemitsu AKUTSU, Saitama (JP); Shinji FUJIMOTO, Saitama (JP); Toru SUKIGARA, Saitama (JP); Shintaro AOYAGI, Saitama (JP)

(21) Appl. No.: 17/199,414

(22) Filed: Mar. 11, 2021

(30) Foreign Application Priority Data
Mar. 19, 2020 (JP) 2020-049220

(51) Int. Cl. H01M 50/51; H01M 10/04

(52) U.S. Cl. CPC H01M 50/51; H01M 10/0413

(57) ABSTRACT

A solid-state battery cell that can enable high output and in which cell terminals can be freely arranged is provided. A solid-state battery cell 100 has a plurality of unit solid-state batteries 10 that each have a negative electrode plate 101, a positive electrode plate 102, and a solid electrolyte layer 103, and a negative electrode collector plate 106 and positive electrode collector plate 107 that are electrically connected to cell terminals, wherein the negative electrode plate 101 and the positive electrode plate 102 each have a plurality of electrodes, the positive electrode collector plate 107 and the negative electrode collector plate 106 are respectively electrically connected to the pluralities of electrodes, and a plurality of the unit solid-state batteries 10 is electrically connected in series by the pluralities of electrodes and housed in a single cell.

This application is based on and claims the benefit of priority from Japanese Patent Application No. 2020-049220, filed on 19 Mar. 2020, the content of which is incorporated herein by reference.

### BACKGROUND OF THE INVENTION

### Field of the Invention

The present invention relates to a solid-state battery cell.

### Related Art

In recent years, electrolyte batteries such as lithium ion secondary batteries, for example, have been provided to serve rapidly increasing demand for secondary batteries that have high capacity and high output. Lithium ion secondary batteries are used as a power source for mobile phones and electric vehicles, for example. A lithium ion secondary battery has a structure in which a separator is caused to be present between a positive electrode and a negative electrode, and the rest of the structure .is filled with a liquid electrolyte.

In order to obtain a high voltage from a secondary battery, it is necessary to connect a plurality of single batteries in series. However, because lithium ion secondary batteries have liquid electrolytes, it is necessary to prevent electrolytic solutions from making contact with one another and causing a short circuit. Accordingly, it is necessary to house the single batteries in respectively different cells, or ensure insulation between single batteries (for example, refer to Patent. Document 1).

Patent Document 1: Japanese Unexamined Patent Application, Publication No. 2013-106502

### SUMMARY OF THE INVENTION

In order to connect batteries that have a liquid electrolyte such as lithium ion secondary batteries in series, there are problems in that, because insulation members or the like are necessary, the number of components increases, the manufacturing cost increases, and the size of each cell increases. In contrast, with a solid-state battery having a solid electrolyte, there is no risk of short circuiting due to contact between respective electrolytes, and it is possible to house and connect in series a plurality of batteries in a single cell. However, a structure relating to connecting a plurality of solid-state batteries in series has not been considered previously.

The present invention is made in light of the above, and an object of the present invention is to provide a solid-state battery cell from which high output can be obtained, and in which it is possible to freely arrange cell terminals.

(1) The present invention relates to a solid-state battery cell including a plurality of unit solid-state batteries that each include a negative electrode plate, a positive electrode plate, and a solid electrolyte layer, and including a negative electrode collector plate and a positive electrode collector plate that are electrically connected to cell terminals, wherein the negative electrode plate and the positive electrode plate each have a plurality of electrodes, the positive electrode collector plate and the negative electrode collector plate are respectively electrically connected to the pluralities of electrodes, and the plurality of unit solid-state batteries is electrically connected in series by the pluralities of electrodes and housed in a single cell.

By virtue of the invention as in (1), the unit solid-state batteries are connected to each other in series by the pluralities of electrodes of the negative electrode plate and the positive electrode plate, and thus internal resistance decreases and high output can be obtained. Because the negative electrode plate and the positive electrode plate are connected to collector plates that are electrically connected to cell terminals, the cell terminals can be freely arranged depending on the shape of the collector plates.

(2) The solid-state battery cell according to (1), wherein the negative electrode collector plate and the positive electrode collector plate are arranged at respective ends of the plurality of unit solid-state batteries in a lamination direction.

By the invention according to (2), it is easy to arrange the cell terminals at respective ends of the unit solid-state batteries in the lamination direction.

(3) The solid-state battery cell according to (2), wherein the negative electrode collector plate and the positive electrode collector plate each have the respective cell terminal, which protrudes externally from a respective end surface of the plurality of unit solid-state batteries in the lamination direction.

By virtue of the invention according to (3), solid-state battery cells can be easily electrically connected in series to each other.

(4) The solid-state battery ceil according to (1), wherein the negative electrode collector plate and the positive electrode collector plate are arranged between the plurality of unit solid-state batteries.

By the invention according to (4), it. is easy to arrange the cell terminals near the center of the unit solid-state batteries in the lamination direction.

(5) The solid-state battery cell according to any one of (1) to (4), wherein each unit solid-state battery is a laminated electrode group in which a plurality of the negative electrode plates, a plurality of the positive electrode plates, and a plurality of the solid electrolyte layers are electrically connected in parallel.

By virtue of the invention according to (5), it is possible to increase the capacity of the solid-state battery cell.

(6) The solid-state battery cell according to (5), wherein each laminated electrode group has an even number of the solid electrolyte layer, and is formed by combining one laminated electrode group, which is arranged adjacent to the negative electrode collector plate and in which one negative electrode plate is arranged as an outermost layer, and another laminated electrode group, which is arranged adjacent to the positive electrode collector plate and in which one positive electrode plate is arranged as an outermost layer.

By virtue of the invention according to (6), it is possible to omit arrangement of an insulation member between a collector plate and an electrode. It is also possible to have the number of positive electrode plates used in the solid-state battery cell be approximately equal to the number of negative electrode plates used in the solid-state battery cell.

(7) The solid-state battery cell according to (5), wherein each laminated electrode group has an odd number of the solid electrolyte layer, and at least one of the condition that electrode plates arranged at respective ends of the solid-state battery cell in a lamination direction of the solid-state battery cell have the same potential difference and the condition that adjacent electrode plates from the plurality of laminated electrode groups have the same potential difference is satisfied.

By virtue of the invention according to (7), it is possible to omit arrangement of at least one of an insulation member arranged between a laminated electrode group and an exterior body, and an insulation member arranged between adjacent laminated electrode groups. It is also possible to have the number of positive electrode plates used in the solid-state battery cell be approximately equal to the number of negative electrode plates used in the solid-state battery cell.

### BRIEF DESCRIPTION OF THE DRAWINGS

FIG. 1A is a schematic view (plan view) of a solid-state battery cell according to a first embodiment;

FIG. 1B is an exploded perspective view of FIG. 1A;

FIG. 2A is a schematic view (plan view) of a solid-state battery cell according to a second embodiment;

FIG. 2B is an exploded perspective view of FIG. 2A;

FIG. 3A is a schematic view (plan view) of a solid-state battery cell according to a third embodiment;

FIG. 3B is an exploded perspective view of FIG. 3A;

FIG. 4A is a schematic view (plan view) of a solid-state battery cell according to a fourth embodiment;

FIG. 4B is an exploded perspective view of FIG. 4A;

FIG. 5A is a schematic view (plan view) of a solid-state battery cell according to a fifth embodiment;

FIG. 5B is an exploded perspective view of FIG. 5A;

FIG. 6A is a schematic view (plan view) of a solid-state battery cell according to a sixth embodiment;

FIG. 6B is an exploded perspective view of FIG. 6A;

FIG. 7A is a schematic view (plan view) of a solid-state battery cell according to a seventh embodiment;

FIG. 7B is an exploded perspective view of FIG. 7A;

FIG. 7C is a plan view of a modification according to the seventh embodiment;

FIG. 8A is a schematic view (plan view) of a solid-state battery cell according to a first reference example;

FIG. 8B is an exploded perspective view of FIG. 8A;

FIG. 9 is a schematic cross-section view of a solid-state battery ceil according to an eighth embodiment;

FIG. 10 is a schematic cross-section view of a solid-state battery cell according to a ninth embodiment;

FIG. 11 is a schematic cross-section view of a solid-state battery cell according to a tenth embodiment;

FIG. 12 is a schematic cross-section view of a solid-state battery cell according to an eleventh embodiment;

FIG. 13 is a schematic cross-section view of a solid-state battery cell according to a twelfth embodiment; and

FIG. 14 is a schematic cross-section view of a solid-state battery cell according to a second reference example.

### DETAILED DESCRIPTION OF THE INVENTION

<Configuration of Solid-State Battery Cell>

### First Embodiment

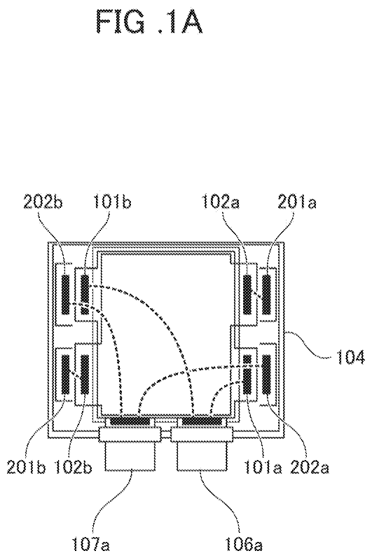

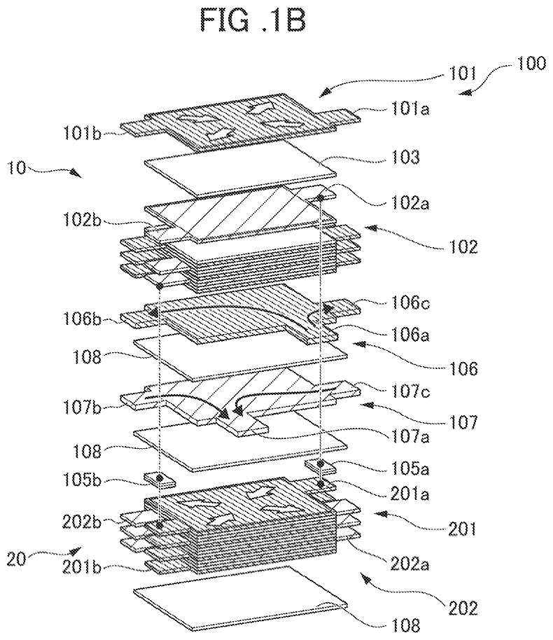

FIGS. 1A and 1B are schematic drawings that illustrate a solid-state battery ceil according to a first embodiment of the present invention. A solid-state battery cell 100 according to the present embodiment has two unit solid-state batteries 10 and 20, an exterior body 104, clad material 105a and 105b, a negative electrode collector plate 106, a positive electrode collector plate 107, a negative electrode cell terminal 106a, a positive electrode cell terminal 107a, and insulation members 108, as illustrated in FIGS. 1A and 1B.

The unit solid-state battery 10 has a negative electrode plate 101, a positive electrode plate 102, and a solid electrolyte layer 103 that; is present between the positive electrode plate 102 and the negative electrode plate 101. The negative electrode plate 101 has two negative electrodes: a negative electrode 101a and a negative electrode 101b. The positive electrode plate 102 has two positive electrodes: a positive electrode 102a and a positive electrode 102b. The unit solid-state battery 10 is a laminated electrode group formed by laminating a plurality of the negative electrode plates 101, a plurality of the positive electrode plates 102, and a plurality of the solid electrolyte layers 103, and connecting these pluralities of electrodes in parallel.

The negative electrode plate 101 and the positive electrode plate 102 are not particularly limited. Normal configurations that are used for positive electrodes and negative electrodes in a solid-state battery can be used for the negative electrode plate 101 and the positive electrode plate 102. The negative electrode plate .101 and the positive electrode plate 102 each include a current collector, an active material, a solid electrolyte, and the like, and may each optionally include a conductive aid, a binder, and the like.

A plurality of electrodes (negative electrodes 101a and 101b, and positive electrodes 102a and 102b) are formed by the current collectors. The material of each current collector is not particularly limited. A positive electrode current collector may be aluminum, an aluminum alloy, stainless steel, nickel, iron, titanium, or the like, for example. A negative electrode current collector may be nickel, copper, stainless steel, or the like, for example. Each current collector may be foil-shaped, plate-shaped, or the like, for example.

The positive electrode active material included in each positive electrode is not particularly limited. A publicly known material that can discharge and occlude a charge transfer medium can be appropriately selected and used as the positive electrode active material. For example, the positive electrode active material may be lithium cobalt oxide, lithium nickelate, lithium manganate, hetero-element-substituted Li—Mn spinel, lithium metal phosphate, or the like.

Similarly, the negative electrode active material included in each negative electrode is not particularly limited. A publicly known material that can discharge and occlude a charge transfer medium can be appropriately selected and used as the negative electrode active material. For example, the negative electrode active material may be a lithium transition metal oxide such as lithium titanate; a transition metal oxide such as TiQ₂, Nb₂O₃, or WO₃; a metal sulfide; a metal nitride; a carbon material such as graphite, soft carbon, or hard carbon; metallic lithium; metallic indium; a lithium alloy; or the like.

The unit solid-state battery 20 has a similar configuration to that of the unit solid-state battery 10, having negative electrode plates 201, positive electrode plates 202, and solid electrolyte layers (not indicated in the drawing) arranged therebetween.

The solid electrolyte layer 103 allows a charge transfer medium to be transmitted between the positive electrode active material included in a respective positive electrode and the negative electrode active material included in a respective negative electrode. The solid electrolyte layer 103 is not particularly limited. For example, it is possible to use a sulfide solid electrolyte material, an oxide solid electrolyte material, a nitride solid electrolyte material, a halide solid electrolyte material, or the like for the solid electrolyte layer 103. The solid electrolyte layer 103 is used after being molded into a sheet shape, for example, similarly to the negative electrode plate 101 and the positive electrode plate 102.

The exterior body 104 is the exterior body for the solid-state battery cell 100, and houses the unit solid-state batteries 10 and 20 inside. The exterior body 104 is not particularly limited, but may be a laminate cell, for example. The laminate cell has a multi-layer structure in which a thermosetting resin layer such as polyolefin is laminated as an outer side on a metal layer including aluminum, stainless steel (SUS), or the like, for example. In addition to the above, the laminate cell may have a layer including, for example, a polyamide such as nylon or a polyester such as polyethylene terephthalate and an adhesive layer including an arbitrarily defined laminate adhesive or the like. The exterior body 104 is not limited to a laminate cell and may be a metal can, for example.

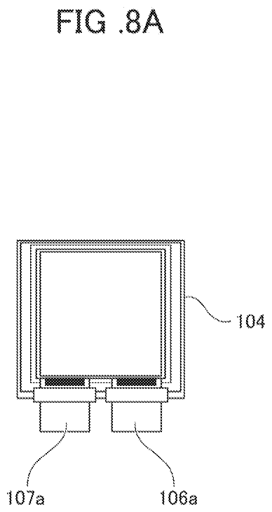

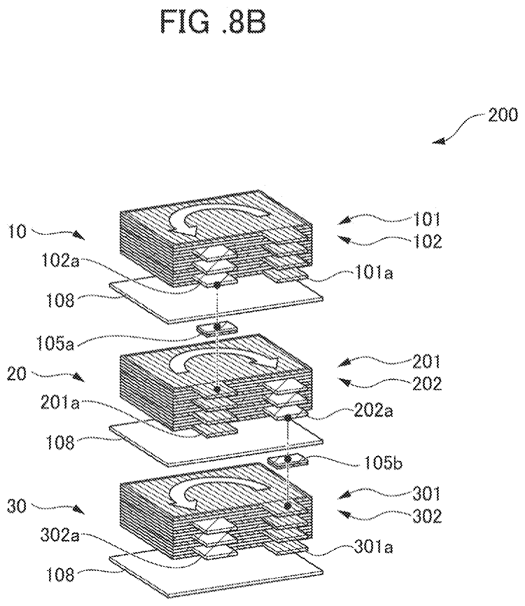

The clad material 105a is electrically connected to a plurality of the negative electrodes 201a and a plurality of the positive electrodes 102a, as schematically illustrated in FIG. 1B and FIG. 1A by broken lines. Similarly, the clad material 105b is electrically connected to a plurality of the negative electrodes 201b and a plurality of the positive electrodes 102b. In other words, the unit solid-state batteries 10 and 20 are electrically connected in series at two locations by the clad material 105a and 105b. By this, as schematically illustrated by the arrows on the negative electrode plate 101 and the negative electrode plate 201 in FIG. 1B, the current that flows through each negative electrode plate is dispersed and is riot concentrated in one location. FIG. 8 is a view illustrating a configuration of a solid-state battery cell 200 according to a first reference example. The solid-state battery cell 200 has three unit solid-state batteries: a unit solid-state battery 10, a unit solid-state battery 20, and a unit solid-state battery 30. With these three unit solid-state batteries, adjacent unit solid-state batteries are connected in series to each other at one location. Accordingly, the internal resistance increases because the current is concentrated on a side where electrodes are provided, as schematically illustrated by arrows on negative electrode plates 101, 201, and 301 in FIG. 8B. In contrast to this, the solid-state battery cell 100 according to the present embodiment can disperse the current flowing in each electrode plate, and thus it is possible to reduce the internal resistance and improve the output from the solid-state battery ceil 100.

The clad material 105a and the clad material 105b each have a clad structure in which different kinds of metals, such as copper or a copper alloy and aluminum or an aluminum alloy for example, are overlapped. The negative electrodes 201a and 201b include copper or a copper alloy, for example. The positive electrodes 102a and 102b include aluminum or an aluminum alloy, for example. It is possible to electrically connect negative electrodes and positive electrodes that use different kinds of metals by using the clad material 105a and the clad material 105b. The method of connection is not particularly limited, but it is possible to use a method such as ultrasonic welding or vibration welding.

The negative electrode collector plate 106 includes a metal plate having the same material properties as the negative electrodes 101a and 101b, for example, and includes copper or a copper alloy, for example. As illustrated in FIG. 1B, the negative electrode collector plate 106 is arranged between the unit solid-state batteries 10 and 20. The negative electrode collector plate 106 is electrically connected to the negative electrode cell terminal 106a. The negative electrode cell terminal 106a is provided separate from the negative electrode collector plate 106. The negative electrode collector plate 106 and the negative electrode cell terminal 106a may be electrically connected, and the negative electrode cell terminal 106a may be a portion of the negative electrode collector plate 106. The negative electrode cell terminal 106a is configured to extend at the front side in FIGS. 1A and 1B, but the negative electrode cell terminal 106a can be arranged at any position by changing the configuration of the negative electrode collector plate 106. For example, the negative electrode cell terminal 106a can be provided at a rear surface side in FIGS. 1A and 1B, or near to either end in the lamination direction.

The negative electrode collector plate 106 has current collection sections 106b and 106c. Current flows from the negative electrode cell terminal 106a towards the current collection sections 106b and 106c, as schematically illustrated by arrows on the negative electrode collector plate 106 in FIG. 1B. The current collection sections 106b and 106c are arranged at positions that are shifted vertically with respect to each other, in the plan view. Accordingly, it is possible to reduce current density and resistance because the current flows uniformly through the negative electrode collector plate 106. As schematically illustrated by a broken line in FIG. 1A, the current collection section 106b bundles and electrically connects the plurality of negative electrodes 101b. The current collection section 106c bundles and electrically connects the plurality of negative electrodes 101a. The method of connection is not particularly limited, but it is possible to use a method such as ultrasonic welding or vibration welding. Welding without requiring a clad material or the like can be performed by making the material properties of the negative electrode collector plate 106 have the same material properties as those of the negative electrodes 101a and 101b.

The positive electrode collector plate 107 includes a metal plate of the same material as that of the positive electrodes 102a and 102b, for example, and includes aluminum or an aluminum alloy, for example. The positive electrode collector plate 107 has a similar configuration to that of the negative electrode collector plate 106, and has the positive electrode cell terminal 107a, and current collection sections 107b and 107c. As illustrated in FIG. 1B, the positive electrode collector plate 107 is arranged between the unit solid-state batteries 10 and 20. Current flows from the current collection sections 107b and 107c to the positive electrode cell terminal 107a, as schematically illustrated by arrows on the positive electrode collector plate 107 in FIG. 1B. The positive electrode ceil terminal 107a can be arranged at any position. The current collection sections 107b and 107c respectively bundle and electrically connect the plurality of positive electrodes 202b and the plurality of positive electrodes 202a.

The insulation members 106 are sheet-shaped members that insulate and prevent, short circuits between the unit solid-state batteries 10 and 20 and between the negative electrode collector plate 106 and the positive electrode collector plate 107, between which differences in potential arise. The insulation member 106 is not. particularly limited as long as it is a member that has insulating properties, and may include a resin material, for example. In the present embodiment, the insulation members 108 are arranged between the negative electrode collector plate 106 and the positive electrode collector plate 107, between the positive electrode collector plate 107 and the unit solid-state battery 20, and between the unit solid-state battery 20 and the exterior body 104 (not illustrated in FIG. 1B).

Description of other embodiments of the present invention is given below. Description regarding configurations similar to that of the first embodiment may be omitted.

### Second Embodiment

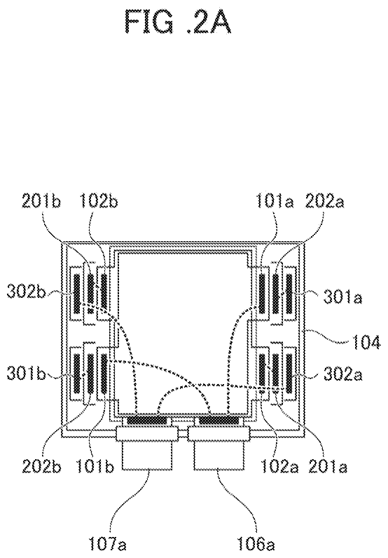

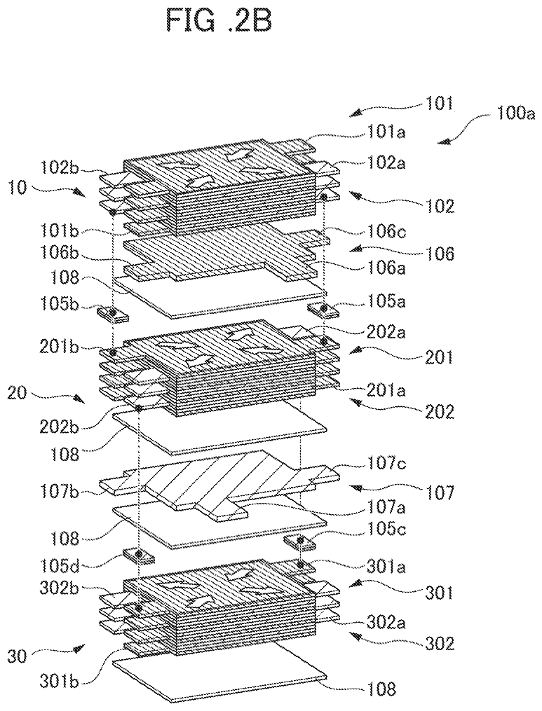

FIGS. 2A and 2B are schematic drawings that illustrate a solid-state battery cell 100a according to a second embodiment of the present invention. The solid-state battery cell 100a has three unit solid-state batteries: a unit solid-state battery 10, a unit solid-state battery 20, and a unit solid-state battery 30. The three unit, solid-state batteries are electrically connected in series inside the solid-state battery cell 100a.

Similarly to the first embodiment, the unit solid-state battery 10 and 20 according to the present embodiment are electrically connected in series at two locations. The unit solid-state battery 20 and 30 according to the present embodiment are also electrically connected in series at two locations. As illustrated in FIGS. 2A and 2B, positive electrodes 102a of the unit solid-state battery 10 are connected to negative electrodes 201a of the unit solid-state battery 20 by clad material 105a. Similarly, positive electrodes 102b of the unit solid-state battery 10 are connected to negative electrodes 201b of the unit solid-state battery 20 by clad material 105b. Positive electrodes 202a of the unit solid-state battery 20 are connected to negative electrodes 301a of the unit solid-state battery 30 by clad material 105c. Similarly, positive electrodes 202b of the unit solid-state battery 20 are connected to negative electrodes 301b of the unit solid-state battery 30 by clad material 105d. Accordingly, with the configuration of the solid-state battery ceil 100a in which three unit solid-state battery are connected in series inside, the exterior body 104, it is also possible to improve output by providing two connection locations, similarly to the first embodiment.

### Third Embodiment

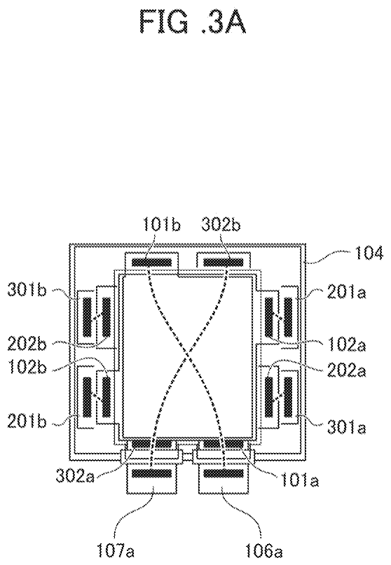

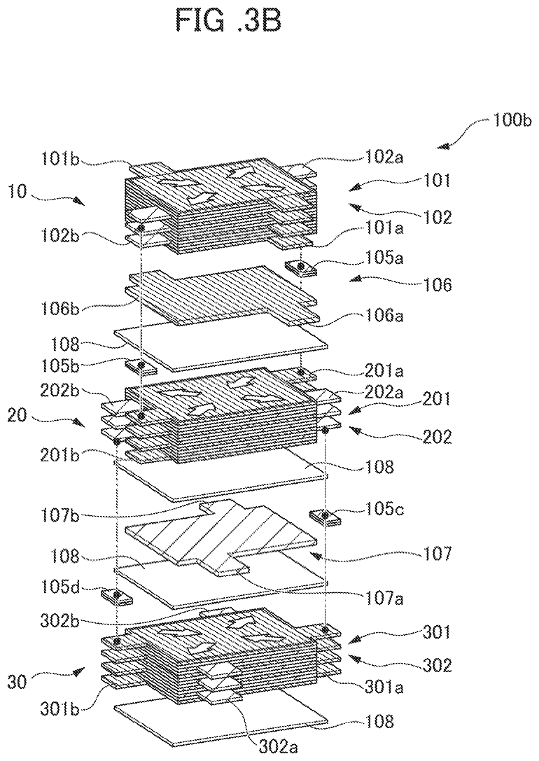

FIGS. 3A and 3B are schematic drawings that illustrate a solid-state battery cell 100b according to a third embodiment of the present invention. The solid-state battery cell 100b has three unit solid-state batteries: a unit solid-state battery 10, a unit solid-state battery 20, and a unit, solid-state battery 30.

As illustrated in FIGS. 3A and 3B, a negative electrode plate 101 according to the present embodiment has negative electrodes 101a and 101b that, are respectively connected to a current collection section 106a and a current collection section 106b of a negative electrode collector plate 106. The direction in which these current collection sections and negative electrodes extend are different to the directions in which the current collection sections and negative electrodes extend in the plan view in the first and second embodiments. The same applies to current collection sections 107a and 107b of a positive electrode collector plate 107, and positive electrodes 302a and 302b. In other words, there is no particular limitation on the directions in which the electrodes and the current collection sections extend. It is possible to combine unit solid-state batteries having electrodes that extend in respectively different directions.

The current collection section 106a has both a function of bundling and electrically connecting the plurality of negative electrodes 101a, and a function of being a negative electrode cell terminal. The current collection section 107a has both a function of bundling and electrically connecting the plurality of positive electrodes 302a, and a function of being a positive electrode cell terminal. By this, it is possible to simplify the configurations of the negative electrode collector plate 106 and the positive electrode collector plate 107 and make them have the same functionality.

### Fourth Embodiment

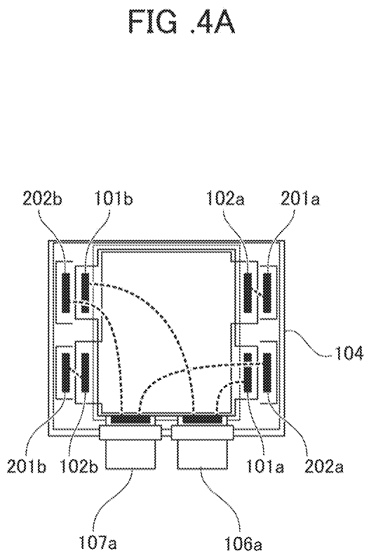

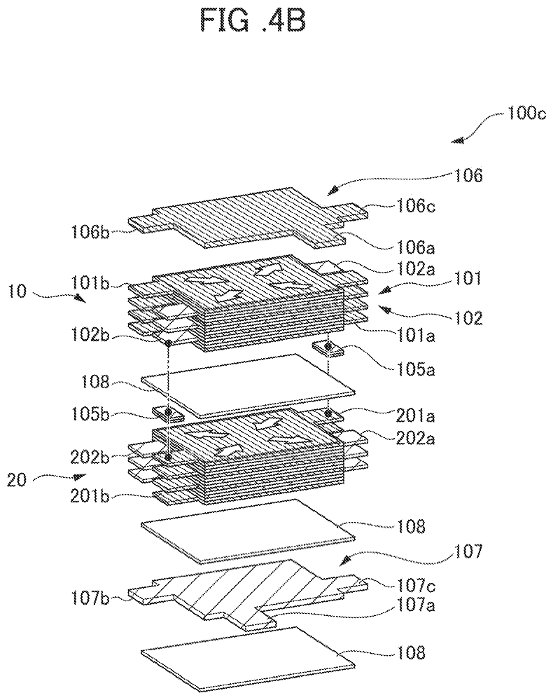

FIGS. 4A and 4B are schematic drawings that; illustrate a solid-state battery cell 100c; according to a fourth embodiment of the present invention. The solid-state battery cell 100c has two unit solid-state batteries: a unit solid-state battery 10, and a unit solid-state battery 20.

As illustrated in FIG. 4B, a negative electrode collector plate 106 and a positive electrode collector plate 107 according to the present embodiment are provided at respective ends of the unit solid-state batteries 10 and 20 in the lamination direction. In the present embodiment, a negative electrode ceil terminal 106a and a positive electrode cell terminal 107a can be provided near respective ends of the unit solid-state batteries 10 and 20 in the lamination direction. Alternatively, configuration may be taken to extend the negative electrode cell terminal 106a and the positive electrode ceil terminal 107a so that the ends of the negative electrode cell terminal 106a and the positive electrode cell terminal 107a are arranged near the center in the lamination direction.

### Fifth Embodiment

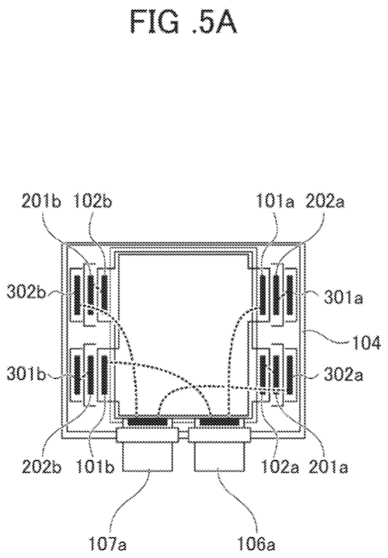

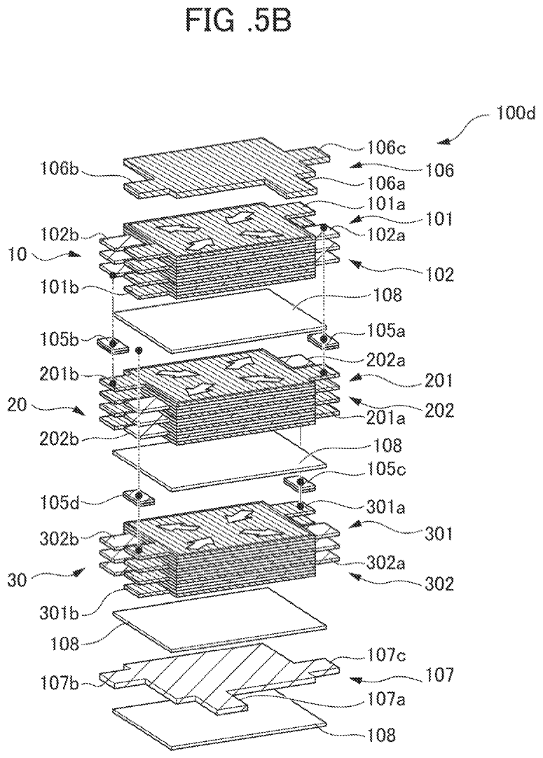

FIGS. 5A and SB are schematic drawings that illustrate a solid-state battery cell 100d according to a fifth embodiment of the present invention. The solid-state battery cell 100d has three unit solid-state batteries: a unit solid-state battery 10, a unit solid-state battery 20, and a unit solid-state battery 30.

A negative electrode collector plate 106 and a positive electrode collector plate 107 according to the present embodiment are respectively provided at respective ends of the unit solid-state batteries 10, 20, and 30 in the lamination direction as illustrated in FIG. 5B, similarly to the fourth embodiment. Even if the number of unit solid-state batteries that are in series in the fourth embodiment is increased, it is possible to configure the solid-state battery cell 100d as in the present embodiment.

### Sixth Embodiment

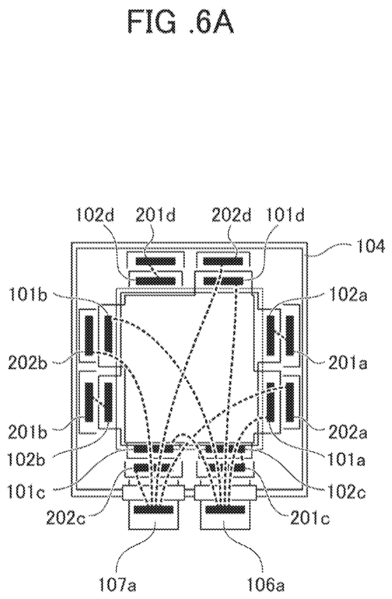

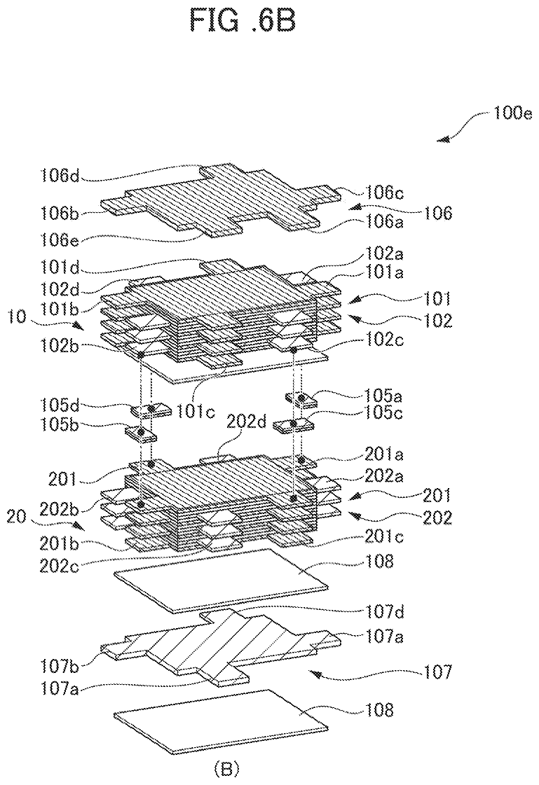

FIGS. 6A and 6B are schematic drawings that illustrate a solid-state battery cell 100e according to a sixth embodiment of the present invention. The solid-state battery cell 100e has two unit, solid-state batteries: a unit solid-state battery 10, and a unit solid-state battery 20.

As illustrated in FIG. 6B, a negative electrode plate 101 of the unit solid-state battery 10 has four negative electrodes: a negative electrode 101a, a negative electrode 101b, a negative electrode 101c, and a negative electrode 101d. Similarly, a positive electrode plate 102 has four positive electrodes: a positive electrode 102a, a positive electrode 102b, a positive electrode 102c, and a positive electrode 102d. It is similar for the unit solid-state battery 20.

As illustrated in FIGS. 6A and 6B, a plurality of the positive electrodes 102a and a plurality of a negative electrodes 201a are electrically connected by a clad material 105a. similarly, a plurality of the positive electrodes 102b and a plurality of a negative electrodes 201b are electrically connected by a clad material 105b, a plurality of the positive electrodes 102c and a plurality of the negative electrodes 201c are electrically connected by a clad material 105c, and a plurality of the positive electrodes 102d and a plurality of a negative electrodes 201d are electrically connected by a clad material 105d. By the foregoing, the unit solid-state batteries 10 and 20 are electrically connected in series at four locations. By this, the solid-state battery cell 100e according to the present embodiment can disperse the current flowing in each electrode plate, and thus it is possible to reduce the internal resistance and improve the output from the solid-state battery cell 100e.

As illustrated in FIG. 6B, a negative electrode collector plate 106 and a positive electrode collector plate 107 according to the present embodiment are respectively provided at respective ends of the unit solid-state batteries 10 and 20 in the lamination direction. The negative electrode collector plate 106 has a negative electrode cell terminal 106a and four current collection sections: a current collection section 106b, a current collection section 106c, a current collection section 106d, and a current collection section 106e. The positive electrode collector plate 107 similarly has four current collection sections: a current collection section 107a, a current collection section 107b, a current collection section 107c, and a current collection section 107d. The current collection section 107a also functions as a positive electrode cell terminal.

### Seventh Embodiment

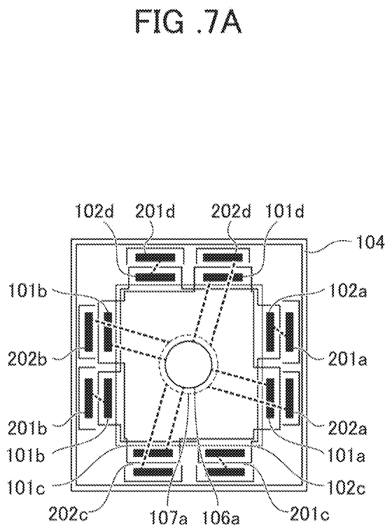

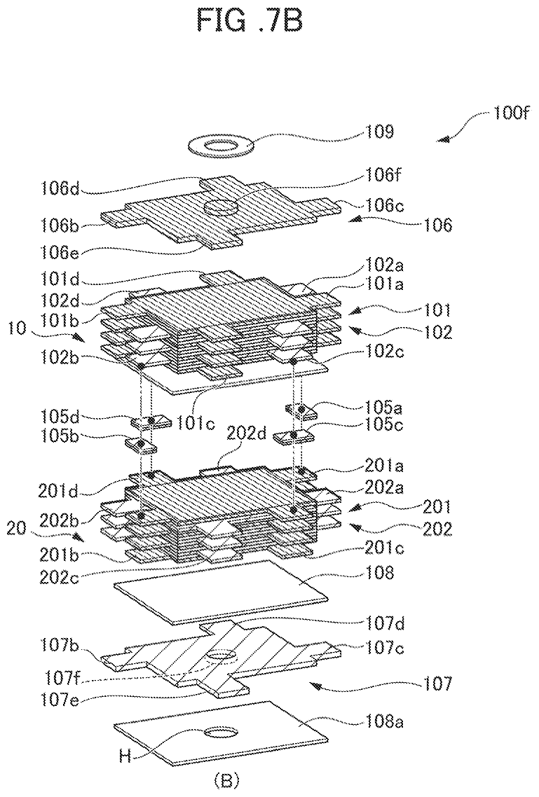

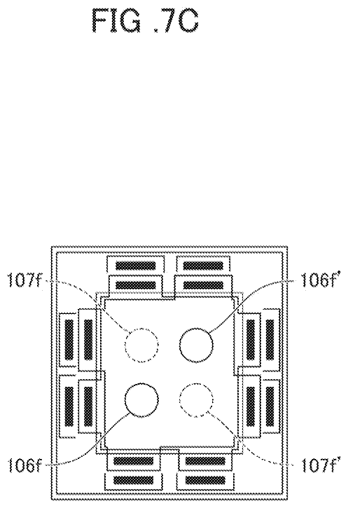

FIGS. 7A and 78 are schematic drawings that illustrate a solid-state battery cell 100f according to a seventh embodiment of the present invention. The solid-state battery cell 100f has two unit solid-state batteries: a unit solid-state battery 10, and a unit solid-state battery 20. The unit solid-state batteries 10 and 20 are electrically connected in series at four locations inside the solid-state batter/cell 100f, similarly to the sixth embodiment.

As illustrated in FIG. 7B, a negative electrode collector plate 106 and a positive electrode collector plate 107 according to the present embodiment are provided at respective ends of the unit solid-state batteries 10 and 20 in the lamination direction. The negative electrode collector plate 106 has a negative electrode cell terminal 106f that protrudes outward from an end surface in the lamination direction of the unit solid-state batteries 10 and 20. A hole (not. illustrated) through which the negative electrode cell terminal 106f can communicate is provided in the exterior body 104, for example, and the negative electrode cell terminal 106f is exposed externally from the solid-state battery cell 100f.

There is no particular limitation as long as there is a configuration in which the negative electrode cell terminal 106f protrudes externally from the solid-state battery cell 100f. The negative electrode cell terminal 106f has a columnar shape, for example. The negative electrode cell terminal 106f may be formed by deforming the center of the negative electrode collector plate 106, for example. Alternatively, the negative electrode ceil terminal 106f may be formed by using welding or the like to join a separate member having the same material properties as that of the negative electrode collector plate 106 to the negative electrode collector plate 106. An insulating material 109 is arranged around the negative electrode cell terminal 106f. The insulating material 109 covers the side surface of the negative electrode cell terminal 106f, and is fixed in contact with the exterior body 104.

A positive electrode cell terminal 107f having a similar configuration to that of the negative electrode cell terminal 106f is also provided on the positive electrode collector plate 107. An insulation member 106a is arranged between the positive electrode collector plate 107 and the exterior body 104. A hole H through which the positive electrode cell terminal 107f can communicate is provided in the insulation member 106a. The positive electrode cell terminal 107f is thus exposed outside of the solid-state battery cell 100f.

The configurations of the negative electrode cell terminal 106f and the positive electrode cell terminal 107f are not limited to as described above. FIG. 7C is a modification of the solid-state battery cell 100f according to the present embodiment. As illustrated in FIG. 7c, the negative electrode cell terminal and the positive electrode cell terminal may respectively include a plurality of negative electrode cell terminals 106f and 106f′ and a plurality of positive electrode cell terminals 107f and 107f′.

By virtue of the solid-state battery cell 100f having the configuration described above, it is possible to easily electrically connect a plurality of the solid-state battery ceils 100f in series by stacking the plurality of the solid-state battery cells 100f and connecting the negative electrode cell terminals and the positive electrode ceil terminals.

<Solid-State Battery Cell Lamination Structure>

Using drawings, description is given below regarding the lamination structure of a solid-state battery cell according to the present invention. The following embodiments may be combined with the configurations of the first, through seventh embodiments described above.

### Eighth Embodiment

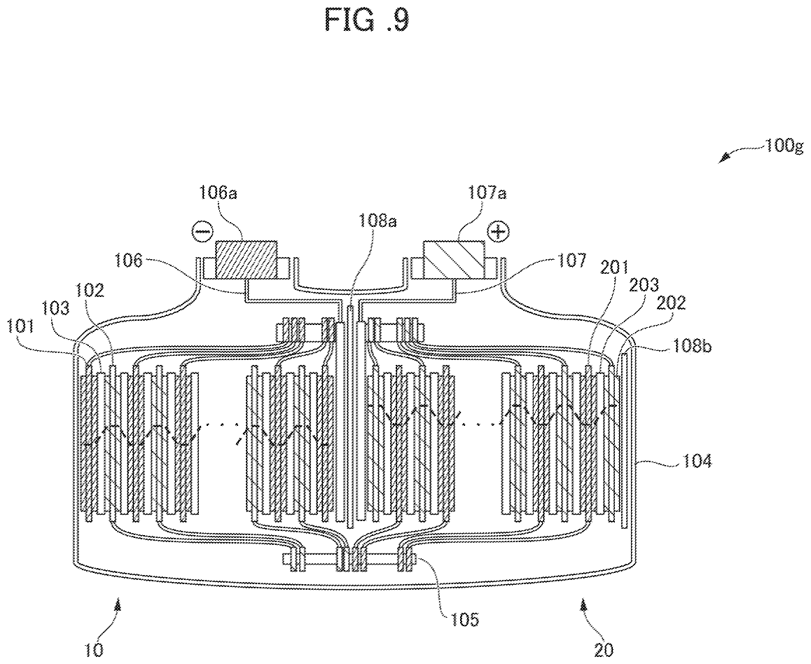

FIG. 9 is a schematic cross-section view that illustrates a solid-state battery cell 100g according to an eighth embodiment of the present invention. The solid-state battery cell 100y has two unit solid-state batteries: a unit solid-state battery 10, and a unit solid-state battery 20. Broken lines in FIG. 9 schematically illustrate the potential of each electrode.

The unit solid-state battery 10 is a laminated electrode group formed by connecting in parallel a plurality of negative electrode plates 101, a plurality of positive electrode plates 102, and a plurality of solid electrolyte layers 103. The unit solid-state battery 10 las an even number of solid electrolyte layers 103. Accordingly, negative electrode plates 101 that are the same kind of electrode plate are arranged as the outermost layers of the unit solid-state battery 10 in the lamination direction. A negative electrode collector plate 106 .is arranged adjacent to the unit solid-state battery 10. By this, a potential difference for the unit solid-state battery 10 is the same as a potential difference for the negative electrode collector plate 106, and thus there is no need to arrange an insulation member between the unit solid-state battery 10 and the negative electrode collector plate 106.

The unit solid-state battery 20 is a laminated electrode group formed by laminating a plurality of negative electrode plates 201, a plurality of positive electrode plates 202, and a plurality of solid electrolyte layers 203, and connecting these pluralities of electrodes in parallel. The unit solid-state battery 20 has an even number of solid electrolyte layers 203. Accordingly, positive electrode plates 202 that are the same kind of electrode plate are arranged as the outermost layers of the unit solid-state battery 20 in the lamination direction. A positive electrode collector plate 107 is arranged adjacent to the unit solid-state battery 20. By this, a potential difference for the unit solid-state battery 20 is the same as a potential difference for the positive electrode collector plate 107, and thus there is no need to arrange an insulation member between the unit solid-state battery 20 and the positive electrode collector plate 107.

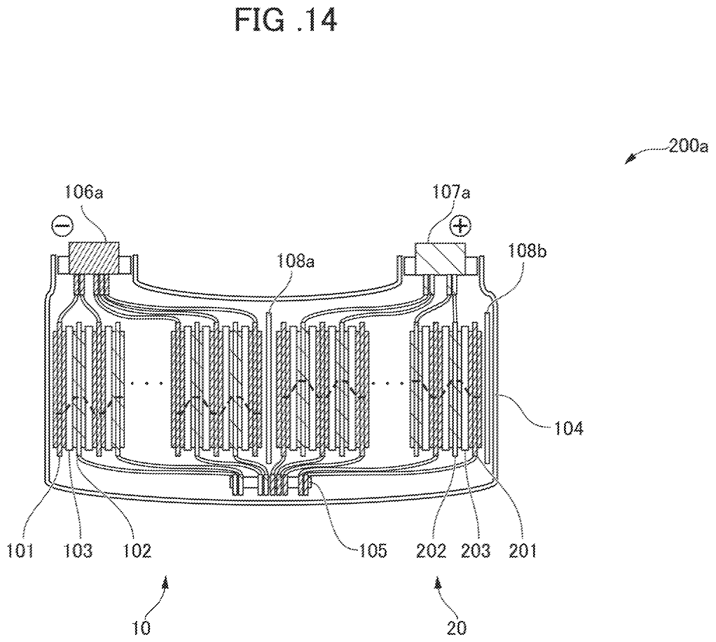

FIG. 14 is a schematic cross-section view of a solid-state battery cell 200a according to a second reference example. The solid-state battery cell 200a is formed by combining unit solid-state batteries in which the electrode plates of the same kind, for example negative electrode plate, are arranged as the outermost layers. With such a configuration, the number of negative electrode plates becomes even larger than the number of positive electrode plates the greater the number of these unit solid-state batteries that are connected in series. By virtue of the solid-state battery cell 100g according to the present embodiment, it is possible to have the same number of negative electrode plates and positive electrode plates by combining the unit solid-state battery 10 and the unit solid-state battery 20 that have the configurations described above. If there is an odd number of unit solid-state battery cells that are connected in series, the number of negative electrode plates and the number of positive electrode plates will differ by one. By this, it is possible to improve the efficiency of producing the solid-state battery cell 100g.

As illustrated in FIG. 9, it is possible to have the only insulation members present in the solid-state battery cell 100g be an insulation member 108a that is arranged between the unit solid-state battery 10 and the unit solid-state battery 20, and an insulation member 108b that is arranged between the unit solid-state battery 20 and the exterior body 104. Accordingly, it is possible to reduce the number of insulation members 108 in comparison to the solid-state battery cell 100 according to the first embodiment, for example. By this, it is possible to reduce the cost of manufacturing the solid-state battery cell 100g.

### Ninth Embodiment

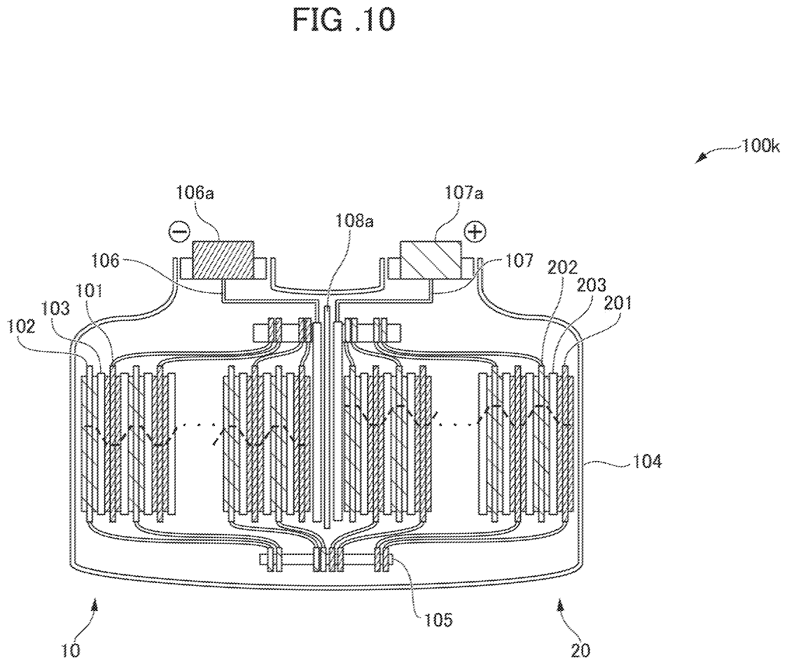

FIG. 10 is a schematic cross-section view that illustrates a solid-state battery cell 100k according to a ninth embodiment of the present invention. The solid-state battery cell 100k has two unit solid-state batteries: a unit solid-state battery 10, and a unit solid-state battery 20.

The unit solid-state battery 10 has an odd number of solid electrolyte layers 103. A negative electrode plate 101 and a positive electrode plate 102, which are different kinds of electrode plates, are respectively arranged as the outermost layers of the unit solid-state battery 10. The unit solid-state battery 20 similarly has an odd number of solid electrolyte layers 203. A negative electrode plate 201 and a positive electrode plate 202, which are different kinds of electrode plates, are respectively arranged as the outermost layers of the unit solid-state battery 20.

A negative electrode plate 101 is arranged as the innermost layer of the unit solid-state battery 10 on the side adjacent to the unit solid-state battery 20. A negative electrode collector plate 106 is arranged adjacent to this negative electrode plate 101. By this, a potential difference for this negative electrode plate 101 is the same as a potential difference for the negative electrode collector plate 106, and thus there is no need to arrange an insulation member between the unit solid-state battery 10 and the negative electrode collector plate 106.

A positive electrode plate 202 is arranged as the innermost layer of the unit solid-state battery 20 on the side adjacent to the unit solid-state battery 10. A positive electrode collector plate 107 is arranged adjacent to this positive electrode plate 202. By this, a potential difference for this positive electrode plate 202 is the same as a potential difference for the positive electrode collector plate 107, and thus there is no need to arrange an insulation member between the unit solid-state battery 20 and the positive electrode collector plate 107.

A plurality of positive electrode plates 102 are electrically connected to a plurality of negative electrode plates 201 by clad material 105. Accordingly, differences in potential are the same for the positive electrode plate 102 and the negative electrode plate 201 that are respective outermost layers of the unit solid-state battery 10 and the unit solid-state battery 20 that are laminated together. In other words, an insulation member is normally arranged between the exterior body 104 and an electrode plate having a high potential, from among electrode plates that are outermost layers and are adjacent to the exterior body 104. However, by virtue of the .solid-state battery cell 100k according to the present embodiment, it is possible to omit arrangement of an insulation member between the exterior body 104 and the electrode plate having the higher potential, because the electrode plates that are the outermost layers and are adjacent to the exterior body 104 have the same potential.

### Tenth Embodiment

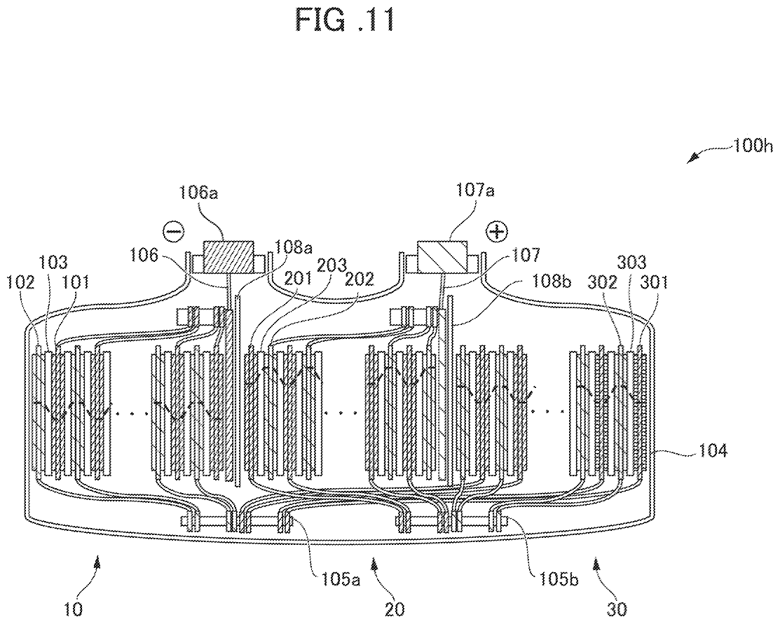

FIG. 11 is a schematic cross-section view that illustrates a solid-state battery cell 100h according to a tenth embodiment of the present invention. The solid-state battery ceil 100b has three unit solid-state batteries: a unit solid-state battery 10, a unit solid-state tottery 20, and a unit solid-state battery 30.

The unit solid-state battery 10 is a laminated electrode group formed by connecting in parallel a plurality of negative electrode plates 101, a plurality of positive electrode plates 102, and a plurality of solid electrolyte layers 103. The unit solid-state battery 10 has an odd number of solid electrolyte layers 103. Accordingly, a negative electrode plate 101 and a positive electrode plate 102 that, are different kinds of electrode plates are arranged as the outermost layers of the unit solid-state battery 10 in the lamination direction.

The unit solid-state batteries 20 and 30 also have odd numbers of solid electrolyte layers 203 and 303, respectively, similarly to the unit solid-state battery 10. Accordingly, it. is possible to have the number of positive electrode plates used in the solid-state battery cell 100h be the same as the number of negative electrode plates used in the solid-state battery cell 100h.

A positive electrode plate 102 is arranged as the outermost layer of the unit solid-state battery 10 on an exterior body 104 side. A positive electrode plate 301 is arranged as the outermost layer of the unit solid-state battery 30 on the exterior body 104 side. A plurality of positive electrode plates 102 are electrically connected to a plurality of negative electrode plates 301 by clad material 105a. Accordingly, there are the same differences in potential for the positive electrode plate 102 and the negative electrode plate 301 that are adjacent to the exterior body 104. An insulation member is normally arranged between the exterior body 104 and the electrode plate having a higher potential, from among electrode plates that are at both ends and are adjacent to the exterior body 104. However, by virtue of the solid-state battery cell 100h according to the present embodiment, it is possible to omit arrangement of: an insulation member between the exterior body 104 and a negative electrode plate or a positive electrode plate.

### Eleventh Embodiment

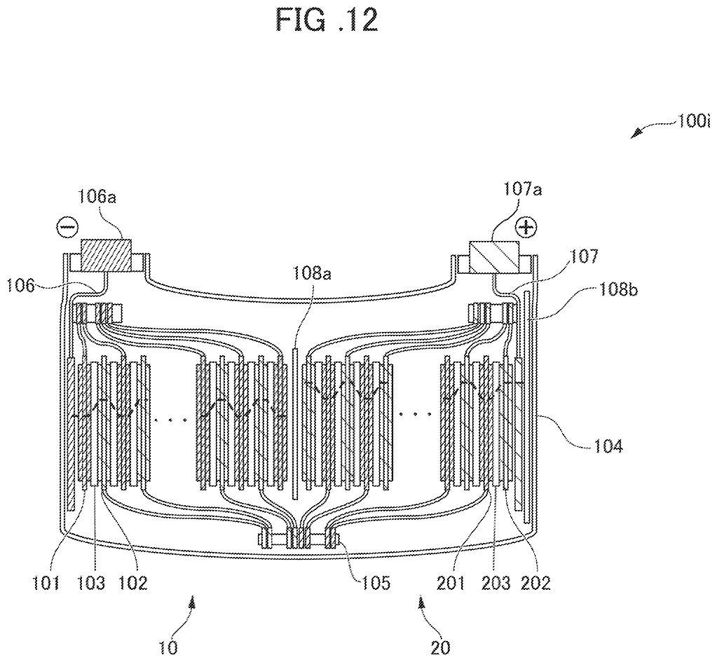

FIG. 12 is a schematic cross-section view that illustrates a solid-state battery cell 100i according to an eleventh embodiment of the present invention. The solid-state battery cell 100i has two unit solid-state batteries: a unit solid-state battery 10, and a unit solid-state battery 20.

The unit solid-state battery 10 has an even number of solid electrolyte layers 103, and negative electrode plates 101 are arranged as the outermost layers. The unit solid-state battery 20 has an even number of solid electrolyte layers 203, and positive electrode plates 202 are arranged as the outermost layers.

A negative electrode collector plate 106 is arranged adjacent to the unit solid-state battery 10. A positive electrode collector plate 107 is arranged adjacent to the unit solid-state battery 20. By this, differences in potential for the collector plates and the unit solid-state batteries become the same, and it is therefore possible to omit arranging insulation members between the collector plates and the unit solid-state batteries. The negative electrode collector plate 106 and the positive electrode collector plate 107 can also be respectively arranged at respective ends of the unit solid-state batteries 10 and 20 in the lamination direction, as illustrated in FIG. 12. Accordingly, the negative electrode cell terminal 106a and the positive electrode cell terminal 107a can be easily arranged at respective ends in the lamination direction.

### Twelfth Embodiment

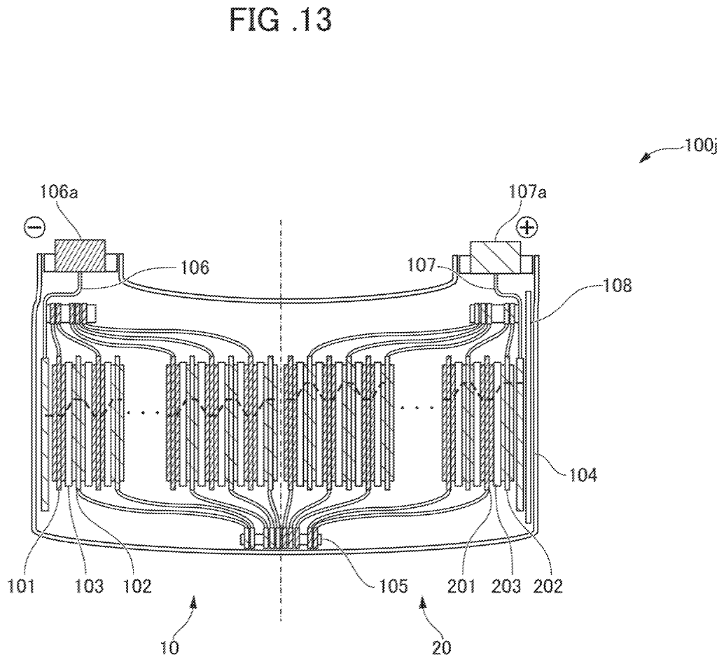

FIG. 13 is a schematic cross-section view that illustrates a solid-state battery cell 100j according to a twelfth embodiment of the present invention. The solid-state battery cell 100j has two unit solid-state batteries: a unit solid-state battery 10, and a unit solid-state battery 20.

The unit solid-state battery 10 has an odd number of solid electrolyte layers 103. A negative electrode plate 101 and a positive electrode plate 102, which are different kinds of electrode plates, are respectively arranged as the outermost layers of the unit solid-state battery 10. The unit solid-state battery 20 similarly has an odd number of solid electrolyte layers 203. A negative electrode plate 201 and a positive electrode plate 202, which are different kinds of electrode plates, are respectively arranged as the outermost layers of the unit solid-state battery 20.

A negative electrode plate 101 is arranged as the outermost layer of the unit solid-state battery 1. A positive electrode plate 202 is arranged as the outermost layer of the unit solid-state battery 20. A plurality of positive electrode plates 102 are electrically connected to a plurality of negative electrode plates 201 by clad material 105. Accordingly, differences in potential are the same for the positive electrode plate 102 and the negative electrode plate 201 that are the respective layers of the unit solid-state battery 10 and the unit solid-state battery 20 that are adjacent to each other, as illustrated in FIG. 13. An insulation member is normally arranged between the unit solid-state battery 10 and the unit solid-state battery 20 in order to prevent a short circuit. However, by virtue of the solid-state battery ceil 100j according to the present embodiment, it is possible to omit arrangement of an insulation member between the unit solid-state battery 10 and the unit solid-state battery 20.

Description is given above regarding desirable embodiments of the present invention, but the present invention is not limited to these embodiments, and results of applying appropriate changes to these embodiments are included in the scope of the present invention.

### EXPLANATION OF REFERENCE NUMERALS

100, 100a, 100b, 100c, 100d, 100e, 100f, 100g, 100h, 100i, 100j, 100k Solid-state battery cell 10, 20, 30 Unit solid-state battery 101, 201, 301 Negative electrode plate 102, 202, 302 Positive electrode plate 101a, 101b, 101c, 101d Negative electrode 102a, 102b, 102c, 102d Positive electrode 103 Solid electrolyte layer 106 Negative electrode collector plate 106a Negative electrode cell terminal (cell terminal) 107 Positive electrode collector plate 106a Positive electrode cell terminal (cell terminal)

What is claimed is:

1. A solid-state battery cell, comprising:
a plurality of unit solid-state batteries each having a negative electrode plate, a positive electrode plate, and a solid electrolyte layer; and
a negative electrode collector plate and a positive electrode collector plate that are each electrically connected to a respective cell terminal,
wherein each negative electrode plate and each positive electrode plate has a plurality of electrodes,
the negative electrode collector plate and the positive electrode collector plate are respectively electrically connected to the pluralities of electrodes, and
the plurality of unit solid-state batteries are electrically connected in series by the pluralities of electrodes and are housed in a single cell.

2. The solid-state battery cell according to claim 1, wherein the negative electrode collector plate and the positive electrode collector plate are arranged at respective ends of the plurality of unit solid-state batteries in a lamination direction.

3. The solid-state battery cell according to claim 2, wherein the negative electrode collector plate and the positive electrode collector plate each have the respective cell terminal, which protrudes externally from a respective end surface of the plurality of unit solid-state batteries in the lamination direction.

4. The solid-state battery cell according to claim 1, wherein the negative electrode collector plate and the positive electrode collector plate are arranged between the plurality of unit solid-state batteries.

5. The solid-state battery cell according to claim 1, wherein each unit solid-state battery is a laminated electrode group in which a plurality of the negative electrode plates, a plurality of the positive electrode plates, and a plurality of the solid electrolyte layers are electrically connected in parallel.

6. The solid-state battery cell according to claim 5, wherein each laminated electrode group has an even number of the solid electrolyte layers, and
is formed by combining one laminated electrode group, which is arranged adjacent to the negative electrode collector plate and in which one negative electrode plate is arranged as an outermost layer, and another laminated electrode group, which is arranged adjacent to the positive electrode collector plate and in which one positive electrode plate is arranged as an outermost layer.

7. The solid-state battery ceil according to claim 5, wherein each laminated electrode group has an odd number of the solid electrolyte layers, and
at least one of the condition that electrode plates arranged at respective ends of the solid-state battery cell in a lamination direction of the solid-state battery cell have the same potential difference and the condition that adjacent electrode plates from the plurality of laminated electrode groups have the same potential difference is satisfied.
